(19) United States
(12) Patent Application Publication
(10) Pub. No.: US 2021/0217146 A1
(43) Pub. Date: Jul. 15, 2021

(54) IMAGE PROCESSING APPARATUS AND IMAGE PROCESSING METHOD

(71) Applicant: SONY SEMICONDUCTOR SOLUTIONS CORPORATION, KANAGAWA (JP)

(72) Inventors: MAKOTO YOKOTA, TOKYO (JP); SHINGO NAGATAKI, KANAGAWA (JP); HIROYUKI TANAKA, KANAGAWA (JP)

(21) Appl. No.: 17/250,705

(22) PCT Filed: May 23, 2019
(86) PCT No.: PCT/JP2019/020496

§ 371 Date: Feb. 22, 2021

(30) Foreign Application Priority Data
Sep. 3, 2018 (JP) 2018-164211

(51) Int. Cl. G06T 5/00; G06T 5/50; G06T 7/00; G06K 9/62

(52) U.S. Cl. CPC G06T 5/005; G06K 9/6202; G06T 7/0002; G06T 5/50

(57) ABSTRACT

An image processing apparatus notifies downstream circuits of the result of anomaly detection without increasing the amount of data involved. The image processing apparatus includes an anomaly detecting section and an output section. The anomaly detecting section detects an anomaly of an image signal from a given pixel. In a case where the anomaly is not detected from the given pixel, the output section outputs a pixel value within a predetermined range. On the other hand, in a case where the anomaly is detected from the given pixel, the output section outputs a pixel value outside the predetermined range. This enables downstream circuits to identify the pixel of which the anomaly is detected by whether or not the pixel value falls within the predetermined range.

### TECHNICAL FIELD

The present technology relates to an image processing apparatus. More particularly, this technology relates to an image processing apparatus for detecting and processing an image signal anomaly, and a processing method for use with the image processing apparatus.

### BACKGROUND ART

The image processing apparatus determines for each image frame whether or not a module performed image processing has failed and, after verifying that the module is normal, proceeds with downstream processes. For example, there is a known technique for inputting failure detection patterns covering conceivable failure patterns to a circuit in order to determine whether or not an output value of the circuit matches an expected value (e.g., see PTL 1).

### CITATION LIST

### Patent Literature

[PTL 1]

Japanese Patent Laid-open No. 2017-092757

### SUMMARY

### Technical Problem

The above-cited existing technique involves detecting failure by use of tag numbers for recognizing the resource portions of a pipeline divided into multiple stages. One problem with this technique is that failure detection data is used to determine whether or not calculation result data matches expected value data, so that the output of the calculation result data leads to increasing the amount of data involved.

The present technology has been devised in view of the above circumstances and is aimed at enabling an image processing apparatus to notify downstream circuits of the result of failure detection without increasing the amount of data involved.

### Solution to Problem

In solving the above problem and according to a first aspect of the present technology, there are provided an image processing apparatus and an image processing method for use therewith, the image processing apparatus including: an anomaly detecting section configured to detect an anomaly of an image signal from a given pixel; and an output section configured to output a pixel value within a predetermined range in a case where the anomaly is not detected from the given pixel and to output a pixel value outside the predetermined range in a case where the anomaly is detected from the given pixel. This provides an effect of outputting a pixel value outside the predetermined range regarding the pixel of which the anomaly is detected.

Also according to the first aspect of the present technology, the image processing apparatus may further include an adding section configured to add a uniform value to pixel values of all pixels included in image data. In the case where the anomaly is detected, the output section may output a value smaller than the added value as a pixel value outside the predetermined range. This provides an effect of outputting a pixel value smaller than the added value on the assumption that a uniform value has been added to the pixel values.

Also according to the first aspect of the present technology, the adding section may add an optical black clamp value for the image data as the uniform value. This provides an effect of outputting a pixel value smaller than the optical black clamp value.

Also according to the first aspect of the present technology, the image processing apparatus may further include an upper limit setting section configured to set an upper pixel value limit for all pixels included in image data. In the case where the anomaly is detected, the output section may output a value larger than the upper limit as the pixel value outside the predetermined range. This provides an effect of outputting a pixel value larger than the upper pixel value limit being presupposed.

Also according to the first aspect of the present technology, the image processing apparatus may further include: an image supplying section configured to supply multiple pieces of image data; and a synthesizing section configured to synthesize the multiple pieces of image data into one piece of image data. The anomaly detecting section may detect the anomaly of a pixel representing a positional displacement of an object by comparing the multiple pieces of image data with one another. The output section may output the pixel value outside the predetermined range with respect to the given pixel of which the anomaly is detected in the synthesized image data. This provides an effect of outputting the pixel value outside the predetermined range with respect to the pixel of which the anomaly is detected in the multiple images yet to be synthesized.

Also according to the first aspect of the present technology, the image supplying section may include an imaging element configured to capture an image of a subject so as to generate pieces of image data having sensitivities different from each other as the multiple pieces of image data. In this case, the imaging element may generate pieces of image data with different exposure times regarding the same subject as the pieces of image data having the different sensitivities.

Also according to the first aspect of the present technology, the image processing apparatus may further include an imaging element configured to capture an image of a subject so as to generate image data. The anomaly detecting section may detect, in the image data, an anomaly attributable to a defect of the imaging element. This provides an effect of outputting information regarding a defective pixel as a pixel value outside the predetermined range.

According to a second aspect of the present technology, there are provided an image processing apparatus and an image processing method for use therewith, the image processing apparatus including: a first circuit including an anomaly detecting section and an output section, the anomaly detecting section detecting an anomaly of an image signal from a given pixel, the output section outputting a pixel value within a predetermined range in a case where the anomaly is not detected from the given pixel, the output section further outputting a pixel value outside the predetermined range in a case where the anomaly is detected from the given pixel; and a second circuit including a correction processing section configured such that, in a case where the pixel value is outside the predetermined range, the correction processing section corrects the pixel value. This provides an effect of causing the pixel value outside the predetermined range to be output from the first circuit to the second circuit regarding the pixel of which the anomaly is detected.

Also according to the second aspect of the present technology, the correction processing section may correct the pixel value through interpolation processing in a spatial direction or in a time direction. This provides an effect of enabling the second circuit to perform the correction based on information from the first circuit.

Also according to the second aspect of the present technology, the second circuit may further include a detection processing section configured to detect a specific pixel value of the pixel output from the first circuit. The correction processing section may correct the specific pixel value to another pixel value. This provides an effect of performing the correction based on information detected by the second circuit.

### BRIEF DESCRIPTION OF DRAWINGS

FIG. 1 is a view depicting a typical configuration of an imaging circuit 100 as a typical image processing apparatus constituting a first embodiment of the present technology.

FIG. 2 is a view depicting an example in which a mobile body detecting section 140 in the first embodiment of the present technology detects a motion artifact.

FIG. 3 is a view depicting an example of OB clamp processing performed by an OB clamp processing section 130 in the first embodiment of the present technology.

FIG. 4 is a view depicting a typical format of frame data 700 output from the imaging circuit 100 to a signal processing circuit 200 in the first embodiment of the present technology.

FIG. 5 is a view depicting a specific example of image data 730 in the first embodiment of the present technology.

FIG. 6 is a flowchart depicting typical processing steps performed by the imaging circuit 100 in the first embodiment of the present technology.

FIG. 7 is a view depicting a typical configuration of an imaging circuit 100 as a typical image processing apparatus constituting a second embodiment of the present technology.

FIG. 8 is a view depicting a typical configuration of a navigation system as a typical image processing apparatus constituting a third embodiment of the present technology.

FIG. 9 is a block diagram depicting an example of schematic configuration of a vehicle control system as a typical mobile body control system to which the technology of the present disclosure may be applied.

FIG. 10 is a view depicting an example of an installation position for an imaging section 12031.

### DESCRIPTION OF EMBODIMENTS

The modes for implementing the present technology (referred to as embodiments) are described below. The description is made in the following order:

1. First embodiment (an example in which information is superposed by use of a value smaller than an OB clamp value)
2. Second embodiment (an example in which information is superposed by use of a maximum pixel value)
3. Third embodiment (navigation system)
4. Fourth embodiment (processing of correcting defective pixels)
5. Examples of application

### 1. First Embodiment

### [Imaging Circuit]

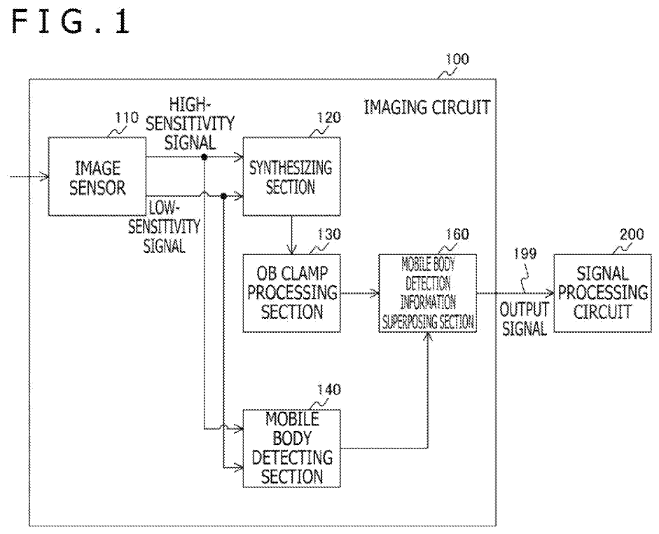

FIG. 1 is a view depicting a typical configuration of an imaging circuit 100 as a typical image processing apparatus constituting a first embodiment of the present technology.

The imaging circuit 100 of the first embodiment includes an image sensor 110, a synthesizing section 120, an OB clamp processing section 130, a mobile body detecting section 140, and a mobile body detection information superposing section 160. Incidentally, the imaging circuit 100 is an example of the first circuit described in the appended claims.

The image sensor 110 captures an image of a subject and performs photoelectric conversion and A/D (Analog-to-Digital) conversion on the captured subject to generate image data as a digital signal. Here, the image sensor 110 is assumed to output signals of different sensitivities, i.e., a high-sensitivity signal and a low-sensitivity signal as two kinds of single-frame image data. To generate these high-sensitivity and low-sensitivity signals may involve performing two exposures with different exposure times on the subject for image data generation. Alternatively, the subject may be sampled twice at different timings during a single exposure in order to generate the image data with different exposure times. Incidentally, the image sensor 110 is an example of the image supplying section or the imaging element described in the appended claims.

The synthesizing section 120 synthesizes the high-sensitivity and low-sensitivity signals generated by the image sensor 110 into single-frame image data of a high dynamic range (HDR). That is, the synthesizing section 120 can generate image data with a wide range of differences in lightness and darkness.

The OB clamp processing section 130 performs, by use of an optical black (OB) region, clamp-based black level adjustment on the single-frame image data synthesized by the synthesizing section 120. As will be discussed later, the OB region is a pixel region surrounding an effective pixel. A photodiode is light-blocked by a film of metal such as aluminum to prevent entry of light from the outside. Using the OB region to perform black level adjustment makes it possible to cancel out the increase in the amount of dark current caused by a rise in temperature, for example. The OB clamp processing section 130 performs black level adjustment on all pixels included in single-frame image data by adding a uniform offset value (OB clamp value) to each of the pixel values. Incidentally, the OB clamp processing section 130 is an example of the adding section described in the appended claims.

The mobile body detecting section 140 detects the motion of an object by comparing the high-sensitivity and low-sensitivity signals generated by the image sensor 110. Because it references images prior to a synthesizing process performed by the synthesizing section 120, the mobile body detecting section 140 can detect false images (Motion Artifact) stemming from motion-triggered positional displacement. It is difficult to determine whether an apparent blur in the synthesized image is a motion artifact or an as-is image. By referencing the images yet to be synthesized, the mobile body detecting section 140 detects the region where a motion artifact has occurred. Incidentally, the mobile body detecting section 140 is an example of the anomaly detecting section described in the appended claims.

The mobile body detection information superposing section 160 superposes the information regarding a motion artifact occurrence region detected by the mobile body detecting section 140 onto the image data from the OB clamp processing section 130. Given the image data from the OB clamp processing section 130, the mobile body detection information superposing section 160 does not overwrite the pixel value of the signal from the region where there is no motion artifact. On the other hand, the pixel value of the signal from the region where a motion artifact has occurred is overwritten with a value that is inherently unlikely after OB clamp processing. The image data having undergone such overwriting is output to the signal processing circuit 200 located downstream via a signal line 199. Incidentally, the mobile body detection information superposing section 160 is an example of the output section described in the appended claims.

The downstream signal processing circuit 200 identifies, in units of pixels, the region where a motion artifact has occurred by extracting, from the image data output via the signal line 199, an inherently unlikely value following OB clamp processing. This enables the downstream signal processing circuit 200 to perform adjustment processing as needed. That is, the adjustment processing that had to be performed traditionally by an upstream imaging circuit can be carried out by the signal processing circuit 200 located downstream. Given that the amount of the image data is reduced after the synthesizing, the traditional signal processing circuit suffers from a drop in the accuracy of motion artifact detection. By contrast, this embodiment improves the accuracy of the detection by detecting any motion artifact using the information before the synthesizing process. Incidentally, the signal processing circuit 200 is an example of the second circuit described in the appended claims.

### [Motion Artifact]

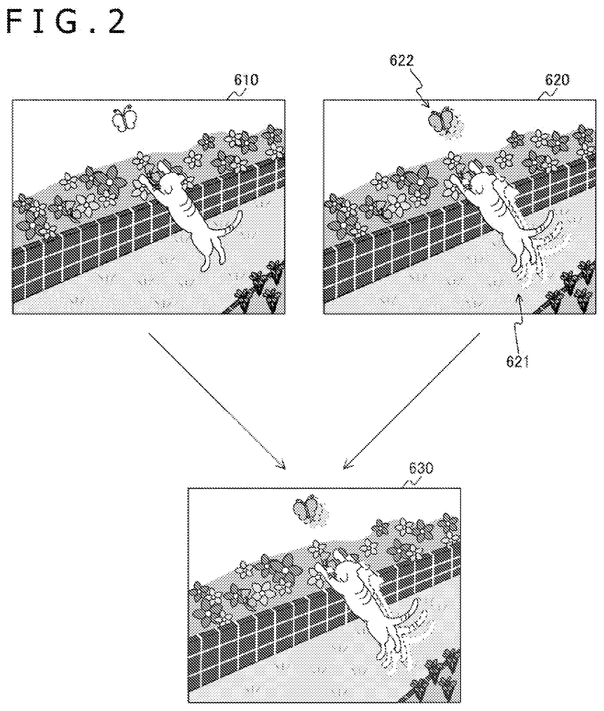

FIG. 2 is a view depicting an example in which the mobile body detecting section 140 in the first embodiment of the present technology detects a motion artifact.

The image sensor 110 generates a low-sensitivity signal image 610 and a high-sensitivity signal image 620. The mobile body detecting section 140 compares the low-sensitivity signal image 610 and the high-sensitivity signal image 620 generated by the image sensor 110, thereby detecting a region where a motion artifact has occurred.

In this example, the motion artifact is detected in a region 622 in which a butterfly is flying and in a region 621 in which a cat is chasing the butterfly. As a result, an HDR image 630 stemming from the synthesizing process by the synthesizing section 120 also develops a motion artifact.

The mobile body detecting section 140 is capable of detecting the region where a motion artifact has occurred in units of pixels. Thus, to express the presence or absence of motion artifact occurrence in units of pixels requires binary information corresponding to the number of pixels per frame. If such information is to be transmitted separately from the imaging circuit 100 to the downstream signal processing circuit 200, the amount of information to be additionally transmitted per frame will be impracticably high.

Thus, in this embodiment, the mobile body detection information superposing section 160 superposes the information regarding the motion artifact occurrence region onto the synthesized image. In this respect, attention is directed to the OB clamp processing section 130 upstream of the mobile body detection information superposing section 160 adding the OB clamp value for black level adjustment.

### [Ob Clamp]

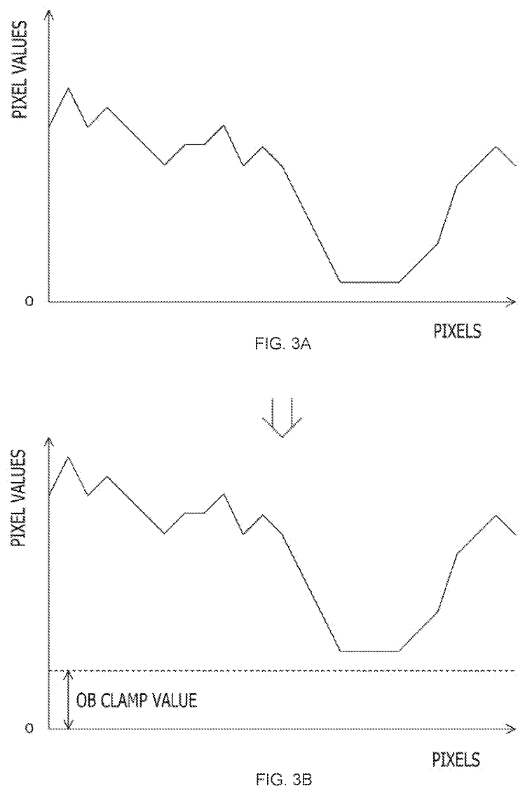

FIG. 3 is a view depicting an example of OB clamp processing performed by the OB clamp processing section 130 in the first embodiment of the present technology.

The horizontal axis of the graphs in FIG. 3 represents the pixels of a single line, and the vertical axis denotes the pixel value of image data corresponding to each of the pixels. Subfigure a in FIG. 3 represents the image data having undergone the synthesizing process performed by the synthesizing section 120. Subfigure b in FIG. 3 denotes the image data stemming from the OB clamp processing carried out by the OB clamp processing section 130.

The OB clamp processing involves adding a uniform OB clamp value to each of the values of all the pixels constituting single-frame image data for black level adjustment. It follows that all pixel values of the image data following the OB clamp processing become equal to or larger than the OB clamp value. In other words, any pixel value smaller than the OB clamp value is inherently unlikely as a pixel value.

Thus, in this embodiment, the mobile body detection information superposing section 160 overwrites the pixel values of the motion artifact occurrence region with a value that is inherently unlikely as a pixel value. This enables the downstream signal processing circuit 200 to identify the region where a motion artifact has occurred by extracting the inherently unlikely values after the OB clamp processing. Meanwhile, the amount of the data to be output remains unchanged because there is no need to add information other than the image data.

### [Data Format]

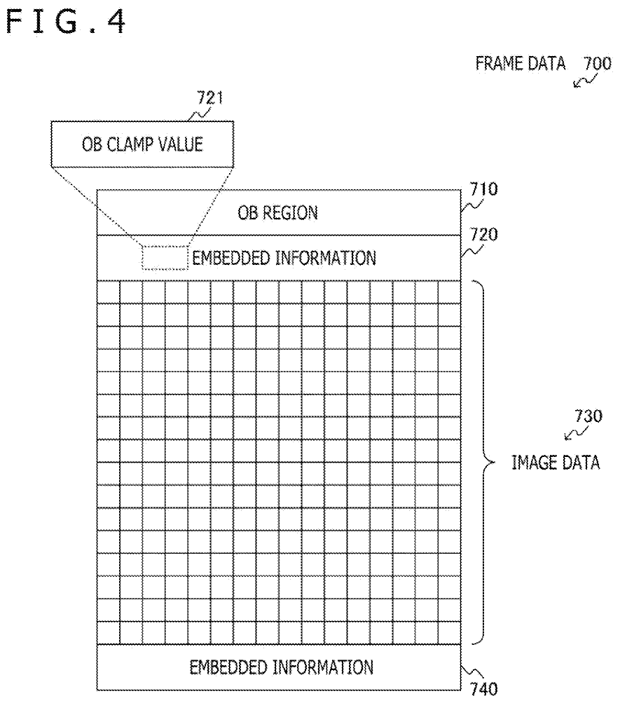

FIG. 4 is a view depicting a typical format of frame data 700 output from the imaging circuit 100 to the signal processing circuit 200 in the first embodiment of the present technology.

The frame data 700 has a format in which an OB region 710, embedded information 720, image data 730, and embedded information 740 are arranged in chronological order.

The OB region 710 is a pixel region for performing black level adjustment. The pixels corresponding to the OB region 710 have a structure similar to that of ordinary pixels but are light-blocked by a metallic film, and no light from the subject enters the pixels. The OB clamp value is determined by use of signals of the OB region 710.

The embedded information 720 is attribute information arranged to precede the image data 730. The OB clamp value determined by use of the signals of the OB region 710 is stored as an OB clamp value 721 in the embedded information 720.

The image data 730 has the pixel values of a single frame arranged therein. The OB clamp value 721 is uniformly added to the pixel values of the image data 730. The pixel values of a motion artifact occurrence region are overwritten with a value inherently unlikely as a pixel value.

The embedded information 740 is another attribute information arranged subsequent to the image data 730.

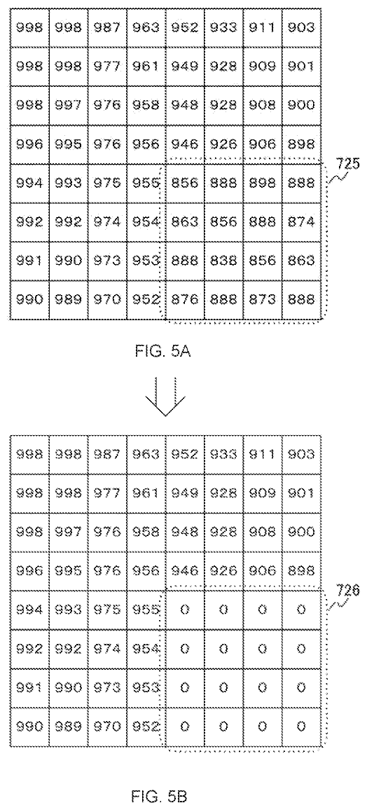

FIG. 5 is a view depicting a specific example of the image data 730 in the first embodiment of the present technology.

Subfigure a in FIG. 5 depicts an example of image data having undergone both the synthesizing process performed by the synthesizing section 120 and the OB clamp processing carried out by the OB clamp processing section 130. Here, it is assumed that a motion artifact is detected in a region 725 by the mobile body detecting section 140.

At this point, as depicted in Subfigure b in FIG. 5, the mobile body detection information superposing section 160 overwrites the pixel values of a region 726 corresponding to the motion artifact occurrence region with a value “0,” for example. The value “0” is a typical value that is inherently unlikely as a pixel value. Any other value may be used alternatively as long as it is smaller than the OB clamp value.

Given the OB clamp value 721 in the embedded information 720, the signal processing circuit 200 located downstream can recognize the OB clamp value added through the OB clamp processing by the OB clamp processing section 130. Thus, the region 726 of which the pixel values turn out to be smaller than the OB clamp value can be recognized as a motion artifact occurrence region. This makes it possible for the signal processing circuit 200 to perform interpolation processing to correct the pixel values in the motion artifact occurrence region of the image data output from the imaging circuit 100.

The interpolation processing performed by the signal processing circuit 200 may involve referencing nearby coordinates in the spatial direction within the same frame or referencing the corresponding coordinates in preceding and subsequent frames in the time direction. As another alternative, these processes may be combined for interpolation processing, i.e., referencing the corresponding coordinates in the preceding and subsequent frames in the time direction as well as referencing nearby coordinates in the spatial direction within these frames.

### [Operation]

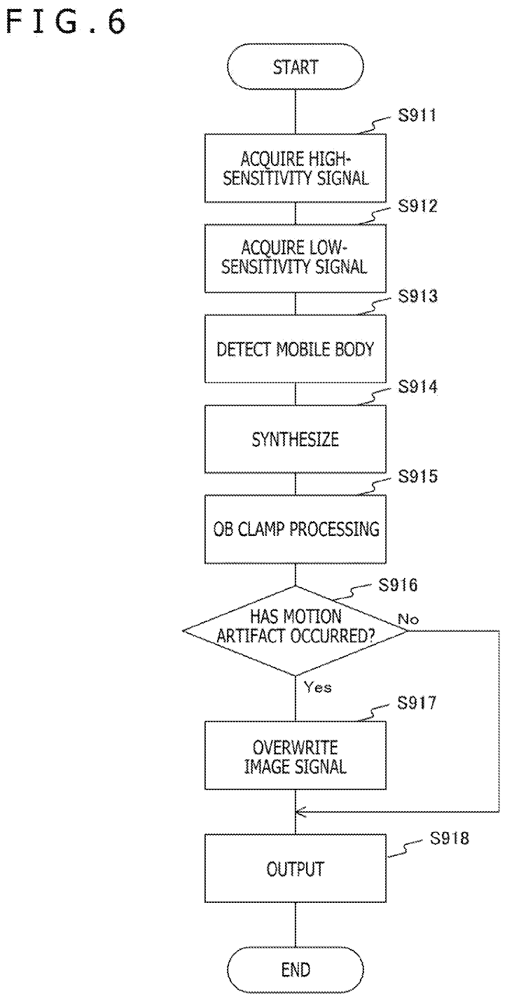

FIG. 6 is a flowchart depicting typical processing steps performed by the imaging circuit 100 in the first embodiment of the present technology.

The image sensor 110 captures an image of a subject so as to acquire a high-sensitivity signal and a low-sensitivity signal (steps S911 and S912). Either the high-sensitivity signal or the low-sensitivity signal may be acquired first.

The mobile body detecting section 140 detects the motion of the captured body by comparing the high-sensitivity signal and low-sensitivity signal thus generated, thereby detecting the motion artifact occurrence region (step S913).

The synthesizing section 120 synthesizes the generated high-sensitivity and low-sensitivity signals into HDR image data (step S914). Given the synthesized image data, the OB clamp processing section 130 acquires an OB clamp value 721 using the OB region 710, thus carrying out black level adjustment through the OB clamp processing (step S915).

The mobile body detection information superposing section 160 superposes the information regarding the motion artifact occurrence region onto the image data having undergone the OB clamp processing. That is, given the pixels of the motion artifact occurrence region (step S916: Yes), the mobile body detection information superposing section 160 overwrites the pixel values of these pixels with an inherently unlikely value (step S917). On the other hand, given the pixels of a region other than the motion artifact occurrence region (step S916: No), the mobile body detection information superposing section 160 does not perform such overwriting.

The pixel data thus obtained is output from the imaging circuit 100 to the signal processing circuit 200 located downstream (step S918).

The first embodiment of the present technology, as described above, detects the motion artifact occurrence region using the image data yet to be synthesized, and overwrites the pixel values of the applicable region with a value smaller than the OB clamp value. This makes it possible for downstream circuits to recognize the motion artifact occurrence region.

That is, because the motion artifact occurrence region is detected by use of the yet-to-be-synthesized information, the detection of the motion artifact occurrence region is more accurate than in the case where the synthesized information, with its reduced information amount, is utilized for detection purposes.

In this case, there is no need to add information, and the amount of the output data remains unchanged. Thus, there is no need to readjust the timing involved or to modify the interface between the imaging circuit 100 and the signal processing circuit 200. Because it is easier for the signal processing circuit 200 to deal with algorithm modifications than for the imaging circuit 100, it is possible to implement correction processing with high scalability.

Further, the information superposed by the imaging circuit 100 is extracted only from the signal level of each pixel, there is no need to install sophisticated detection algorithm. This in turn contributes presumably to downsizing the scale of the signal processing circuit 200.

### 2. Second Embodiment

On the assumption that any value smaller than the OB clamp value is inherently unlikely as a pixel value, the above-described first embodiment outputs the information regarding the motion artifact occurrence region using a range of lower pixel value limits. On the other hand, a range of upper pixel value limits may be utilized instead. A second embodiment involves putting a limit on maximum pixel values and, by use of pixel values exceeding the maximum pixel value, outputting the information regarding the motion artifact occurrence region.

### [Imaging Circuit]

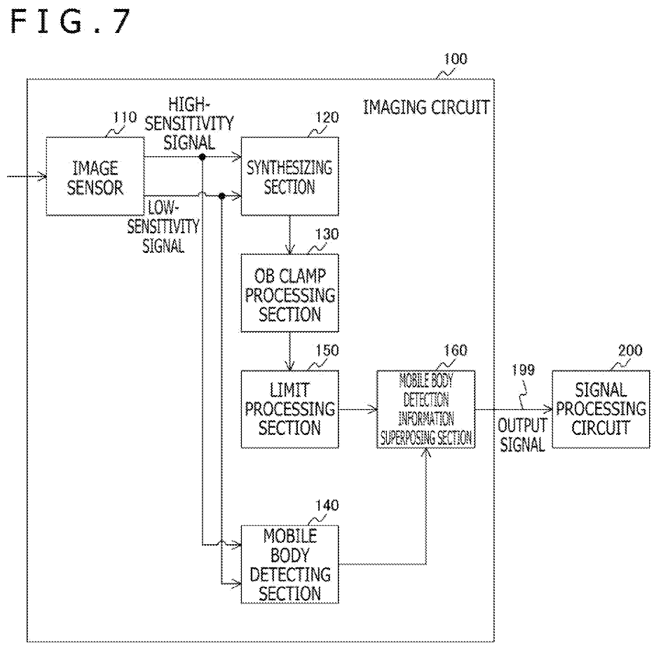

FIG. 7 is a view depicting a typical configuration of the imaging circuit 100 as a typical image processing apparatus constituting the second embodiment of the present technology.

The imaging circuit 100 in the second embodiment is the imaging circuit 100 of the first embodiment supplemented with a limit processing section 150. With respect to the pixels of the image data from the OB clamp processing section 130, the limit processing section 150 performs a process of restricting (limiting) maximum pixel values to a specific value.

If the bit width of a pixel value is assumed here to be 10 bits, the pixel can express a value ranging from “0” to “1023.” In this case, the limit processing section 150 performs a process of limiting the maximum value to “1020” in order to handle “1021,” “1022,” and “1023” as inherently unlikely values for the pixels.

As a result, regarding the pixels corresponding to the motion artifact occurrence region detected by the mobile body detecting section 140, the mobile body detection information superposing section 160 overwrites the pixel values with “1021,” for example. This enables the downstream signal processing circuit 200 to correct the pixels of which the pixel values turn out to be “1021.”

As described above, the second embodiment of the present technology detects the motion artifact occurrence region by use of the image data yet to be synthesized, and overwrites the pixel values of the applicable region with a value exceeding the maximum value determined by the limit processing section 150. This makes it possible for downstream circuits to recognize the motion artifact occurrence region.

### 3. Third Embodiment

It is explained that the above embodiments process the motion artifact using the imaging circuit 100 in particular. A third embodiment in the ensuing explanation focuses on the processing by the signal processing circuit 200 located downstream of the imaging circuit 100.

### [Navigation System]

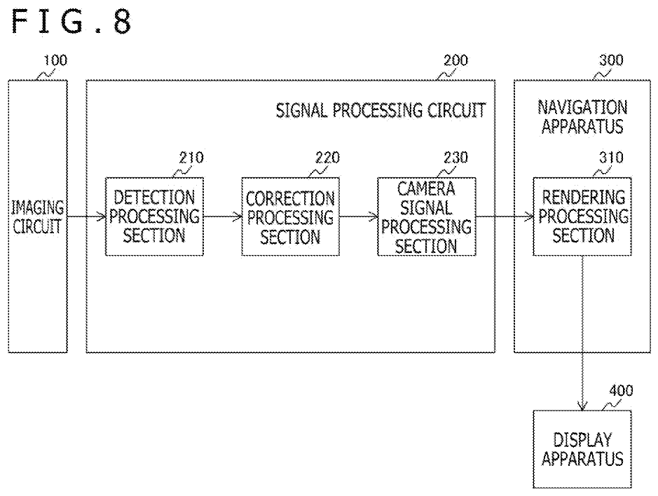

FIG. 8 is a view depicting a typical configuration of a navigation system as a typical image processing apparatus constituting the third embodiment of the present technology. This navigation system is assumed to include the imaging circuit 100 of the first or the second embodiment as an upstream circuit and include the signal processing circuit 200, a navigation apparatus 300, and a display apparatus 400 as downstream circuits.

The signal processing circuit 200 is a circuit that performs predetermined signal processing on image data signals output from the imaging circuit 100. The signal processing circuit 200 includes a detection processing section 210, a correction processing section 220, and a camera signal processing section 230.

The detection processing section 210 detects a pixel region targeted for correction. Out of the pixels of the image data 730 in the frame data 700 output from the imaging circuit 100, the detection processing section 210 detects those pixels of which the values are inherently unlikely as pixel values, the detected pixels constituting a motion artifact occurrence region. For example, as explained above in connection with the first embodiment, the pixels with their pixel values smaller than the OB clamp value are detected. Alternatively, as discussed above in connection with the second embodiment, the pixels with their pixel values exceeding the maximum limit are detected.

Also, the detection processing section 210 may detect a pixel region targeted for correction on the basis of the pixel values of the image data 730. For instance, given the image data captured by a vehicle-mounted camera, there are cases in which the white lines delimiting the traffic lanes are bordered with unnatural colors indicative of a typical motion artifact. Thus, apart from the detection of motion artifact by the imaging circuit 100, the detection processing section 210 may perform image processing on the image data in order to detect a motion artifact occurrence region. In this case, the image processing may involve detecting line edges and finding colors nearby that are unnatural as the colors of the road surface, for example.

The correction processing section 220 performs a process of correcting the pixel data of the motion artifact occurrence region detected by the detection processing section 210. As discussed above, the correction processing section 220 may perform interpolation processing in reference to nearby coordinates in the spatial direction within the frame or in reference to the corresponding coordinates in preceding and subsequent frames in the time direction. As another alternative, these processes may be combined for interpolation processing, i.e., referencing the corresponding coordinates in the preceding and subsequent frames in the time direction as well as referencing nearby coordinates in the spatial direction within these frames.

Also, the correction processing section 220 may perform correction processing that involves replacing the signal levels of the pixels in the motion artifact occurring on the above-mentioned white line borders with grey or other inconspicuous colors.

The camera signal processing section 230 performs other camera signal processing. Specifically, the camera signal processing section 230 is assumed to carry out a process of subtracting the added OB clamp value, a process of correcting defective pixels, a process of converting RAW data into RGB format, a process of reproducing colors, and the like.

The navigation apparatus 300 performs processes of displaying on a navigation screen the image data output from the signal processing circuit 200. The navigation apparatus 300 includes a rendering processing section 310 for rendering image data. The display apparatus 400 displays the navigation screen.

In the third embodiment, as described above, the imaging circuit 100 and the signal processing circuit 200 detect the motion artifact occurrence region, with the signal processing circuit 200 performing correction processing accordingly. This makes it possible to reduce the false colors that may be ultimately displayed on the screen of the navigation system.

### 4. Fourth Embodiment

The above-described embodiments focus on superposing the information regarding the motion artifact occurrence region onto pixel data. It is to be noted, however, that the information to be superposed on the pixel data is not limited to the information regarding the motion artifact occurrence region.

For example, the coordinates of defective pixels may be superposed on the pixel data for correction processing by the camera signal processing section 230. The coordinates of defective pixels detected by testing before shipment from the factory may be set beforehand in registers of the signal processing circuit 200. The defective pixels that may occur thereafter need to be reported separately from the imaging circuit 100 to the signal processing circuit 200. In such a case, the relevant information may be superposed onto the pixel data so as to be reported to downstream circuits without increasing the amount of data involved.

### 5. Examples of Application

The technology of the present disclosure (the present technology) may be applied to diverse products. For example, the technology may be implemented as an apparatus to be mounted on such mobile bodies as automobiles, electric vehicles, hybrid electric vehicles, motorcycles, bicycles, personal mobility devices, aircraft, drones, ships, and robots.

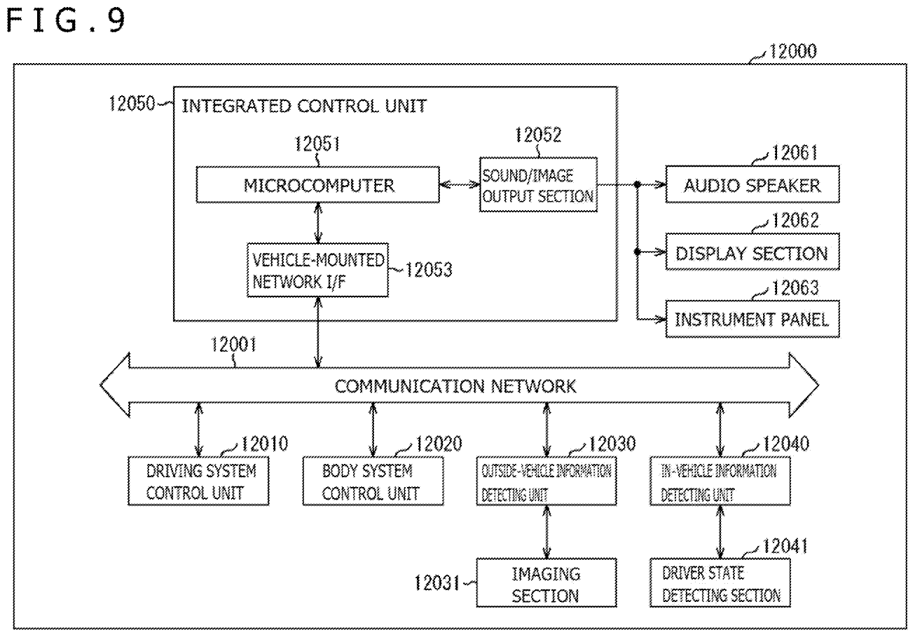

FIG. 9 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 9, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 9, an audio speaker 12061, a display section 12062, and an instrument panel 12063 are illustrated as the output device. The display section 12062 may, for example, include at least one of an on-board display or a head-up display.

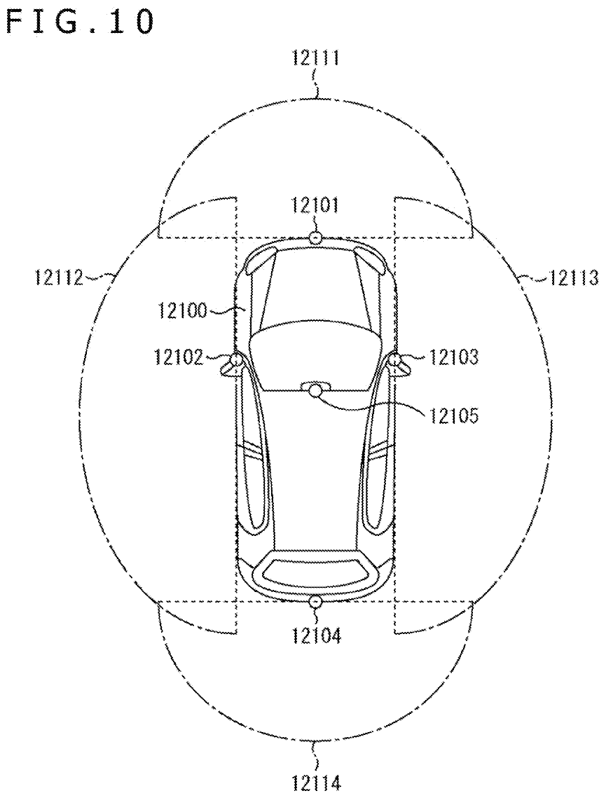

FIG. 10 is a diagram depicting an example of the installation position of the imaging section 12031.

In FIG. 10, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 10 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

Explained above is an example of the vehicle control system to which the technology of the present disclosure may be applied. The technology of this disclosure may be applied to the imaging section 12031 among the components descried above. Specifically, from the pixel data captured by the imaging section 12031, the imaging section 12031 detects the motion artifact occurrence region and has the correction processing performed thereon accordingly. This makes it possible to implement the above-mentioned automatic driving and driving assistance.

The embodiments described above are merely examples in which the present technology may be implemented. The particulars of the embodiments correspond basically to the inventive matters claimed in the appended claims. Likewise, the inventive matters named in the appended claims correspond basically to the particulars of the embodiments with the same names in the foregoing description of the preferred embodiments of the present technology. However, these embodiments and other examples are not limitative of the present technology that may also be implemented using various modifications and alterations of the embodiments so far as they are within the scope of the appended claims.

The procedures discussed above in connection with the embodiments may be construed as constituting a method having a series of such procedures. Also, the procedures may be construed as forming a program for causing a computer to execute a series of such procedures, or as constituting a recording medium storing such a program. The recording medium may be a CD (Compact Disc), an MD (MiniDisc), a DVD (Digital Versatile Disc), a memory card, or a Blu-ray Disc (registered trademark), for example.

The advantageous effects stated in this description are only examples and not limitative of the present technology that may also provide other advantages.

The present technology may be implemented preferably in the following configurations:

(1) An image processing apparatus including:

an anomaly detecting section configured to detect an anomaly of an image signal from a given pixel; and

an output section configured to output a pixel value within a predetermined range in a case where the anomaly is not detected from the given pixel and to output a pixel value outside the predetermined range in a case where the anomaly is detected from the given pixel.

(2) The image processing apparatus as stated in paragraph (1) above, further including an adding section configured to add a uniform value to pixel values of all pixels included in image data,

in which, in the case where the anomaly is detected, the output section outputs a value smaller than the added value as a value outside the predetermined range.

(3) The image processing apparatus as stated in paragraph (2) above, in which the adding section adds an optical black clamp value for the image data as the uniform value.

(4) The image processing apparatus as stated in paragraph (1) above, further including:

an upper limit setting section configured to set an upper pixel value limit for all pixels included in image data,

in which, in the case where the anomaly is detected, the output section outputs a value larger than the upper limit as the pixel value outside the predetermined range.

(5) The image processing apparatus as stated in any one of paragraphs (1) to (4) above, further including:

an image supplying section configured to supply a plurality of pieces of image data; and

a synthesizing section configured to synthesize the plurality of pieces of image data into one piece of image data,

in which the anomaly detecting section detects the anomaly of a pixel representing a positional displacement of an object by comparing the plurality of pieces of image data with one another, and

in which the output section outputs the pixel value outside the predetermined range with respect to the given pixel of which the anomaly is detected in the synthesized image data.

(6) The image processing apparatus as stated in paragraph (5) above, in which the image supplying section includes an imaging element configured to capture an image of a subject so as to generate pieces of image data having sensitivities different from each other as the plurality of pieces of image data.

(7) The image processing apparatus as stated in paragraph (6) above, in which the imaging element generates pieces of image data with different exposure times regarding the same subject as the pieces of image data having the different sensitivities.

(8) The image processing apparatus as stated in any one of paragraphs (1) to (4) above, further including:

an imaging element configured to capture an image of a subject so as to generate image data,

in which the anomaly detecting section detects, in the image data, an anomaly attributable to a defect of the imaging element.

(9) An image processing apparatus including:

a first circuit including an anomaly detecting section and an output section, the anomaly detecting section detecting an anomaly of an image signal from a given pixel, the output section outputting a pixel value within a predetermined range in a case where the anomaly is not detected from the given pixel, the output section further outputting a pixel value outside the predetermined range in a case where the anomaly is detected from the given pixel; and

a second circuit including a correction processing section configured such that, in a case where the pixel value is outside the predetermined range, the correction processing section corrects the pixel value.

(10) The image processing apparatus as stated in paragraph (9) above, in which the correction processing section corrects the pixel value through interpolation processing in a spatial direction or in a time direction.

(11) The image processing apparatus as stated in paragraph (9) or (10) above,

in which the second circuit further includes a detection processing section configured to detect a specific pixel value of the pixel output from the first circuit, and

in which the correction processing section corrects the specific pixel value to another pixel value.

(12) An image processing method including the steps of:

causing an anomaly detecting section to detect an anomaly of an image signal from a given pixel; and

causing an output section to output a pixel value within a predetermined range in a case where the anomaly is not detected from the given pixel and to output a pixel value outside the predetermined range in a case where the anomaly is detected from the given pixel.

### REFERENCE SIGNS LIST

100 Imaging circuit
110 Image sensor
120 Synthesizing section
130 OB clamp processing section
140 Mobile body detecting section
150 Limit processing section
160 Mobile body detection information superposing section
200 Signal processing circuit
210 Detection processing section
220 Correction processing section
230 Camera signal processing section
300 Navigation apparatus
310 Rendering processing section
400 Display apparatus
12031 Imaging section

1. An image processing apparatus comprising:
an anomaly detecting section configured to detect an anomaly of an image signal from a given pixel; and
an output section configured to output a pixel value within a predetermined range in a case where the anomaly is not detected from the given pixel and to output a pixel value outside the predetermined range in a case where the anomaly is detected from the given pixel.

2. The image processing apparatus according to claim 1, further comprising:
an adding section configured to add a uniform value to pixel values of all pixels included in image data,
wherein, in the case where the anomaly is detected, the output section outputs a value smaller than the added value as a value outside the predetermined range.

3. The image processing apparatus according to claim 2, wherein
the adding section adds an optical black clamp value for the image data as the uniform value.

4. The image processing apparatus according to claim 1, further comprising:
an upper limit setting section configured to set an upper pixel value limit for all pixels included in image data,
wherein, in the case where the anomaly is detected, the output section outputs a value larger than the upper limit as the pixel value outside the predetermined range.

5. The image processing apparatus according to claim 1, further comprising:
an image supplying section configured to supply a plurality of pieces of image data; and
a synthesizing section configured to synthesize the plurality of pieces of image data into one piece of image data,
wherein the anomaly detecting section detects the anomaly of a pixel representing a positional displacement of an object by comparing the plurality of pieces of image data with one another, and
wherein the output section outputs the pixel value outside the predetermined range with respect to the given pixel of which the anomaly is detected in the synthesized image data.

6. The image processing apparatus according to claim 5, wherein the image supplying section includes an imaging element configured to capture an image of a subject so as to generate pieces of image data having sensitivities different from each other as the plurality of pieces of image data.

7. The image processing apparatus according to claim 6, wherein the imaging element generates pieces of image data with different exposure times regarding a same subject as the pieces of image data having the different sensitivities.

8. The image processing apparatus according to claim 1, further comprising:
an imaging element configured to capture an image of a subject so as to generate image data,
wherein the anomaly detecting section detects, in the image data, an anomaly attributable to a defect of the imaging element.

9. An image processing apparatus comprising:
a first circuit including an anomaly detecting section and an output section, the anomaly detecting section detecting an anomaly of an image signal from a given pixel, the output section outputting a pixel value within a predetermined range in a case where the anomaly is not detected from the given pixel, the output section further outputting a pixel value outside the predetermined range in a case where the anomaly is detected from the given pixel; and
a second circuit including a correction processing section configured such that, in a case where the pixel value is outside the predetermined range, the correction processing section corrects the pixel value.

10. The image processing apparatus according to claim 9, wherein the correction processing section corrects the pixel value through interpolation processing in a spatial direction or in a time direction.

11. The image processing apparatus according to claim 9,
wherein the second circuit further includes a detection processing section configured to detect a specific pixel value of the pixel output from the first circuit, and
wherein the correction processing section corrects the specific pixel value to another pixel value.

12. An image processing method comprising the steps of:
causing an anomaly detecting section to detect an anomaly of an image signal from a given pixel; and
causing an output section to output a pixel value within a predetermined range in a case where the anomaly is not detected from the given pixel and to output a pixel value outside the predetermined range in a case where the anomaly is detected from the given pixel.
